(19) United States
(12) Patent Application Publication
(10) Pub. No.: US 2026/0316701 A1
(43) Pub. Date: Oct. 15, 2026

(54) ENHANCED DIGITAL AUDIO SAFETY VERIFICATION SYSTEM

(71) Applicant: VISTEON GLOBAL TECHNOLOGIES, INC., Van Buren Township, MI (US)

(72) Inventors: Etienne Jacques Marie Barbaux, Chars (FR); Stephen J. Adams, Chelmsford (GB); Barani Sree M, Chennai (IN)

(73) Assignee: VISTEON GLOBAL TECHNOLOGIES, INC., Van Buren Township, MI (US)

(21) Appl. No.: 19/644,709

(22) Filed: Apr. 10, 2026

Related U.S. Application Data
(60) Provisional application No. 63/787,424, filed on Apr. 11, 2025.

(51) Int. Cl. B60R 16/023; B60W 50/14

(52) U.S. Cl. CPC B60R 16/023; B60W 50/14

(57) ABSTRACT

An enhanced digital audio safety verification system includes a memory, a processor and an amplifier. The memory stores multiple audible safety messages and multiple inaudible safety codes. The processor receives a safety context of a vehicle, selects a corresponding safety message and a corresponding safety code based on the safety context, and adds the corresponding safety message to the corresponding safety code to generate a coded message. The amplifier drives a load with a current based on the coded message, and presents a current feedback signal representative of the current driven to the load while playing the coded message. The processor subsequently decodes the current feedback signal, and generates a report signal that identifies which of the plurality of safety messages was presented to the load based on the decode of the current feedback signal.

### CROSS-REFERENCE TO RELATED APPLICATIONS

This application claims the benefit of U.S. Provisional Application No. 63/787,424, filed Apr. 11, 2025, which is hereby incorporated by reference in its entirety.

### TECHNICAL FIELD

The present disclosure generally relates to systems and methods for enhanced digital audio safety verification system,

### BACKGROUND

Functional safety and ISO 26262 compliance are now being implemented in road vehicles. Existing audio-based solutions either mute non-safety audio source while playing a Safety content or involve two independent audio channels, an audio channel for safety sounds, and another audio channel for media, entertainment and sometimes noise cancellation. Consequences of having two independent solutions are cost, packaging, and power/thermal considerations.

Accordingly, those skilled in the art continue with research and development efforts in the field of single-channel audio safety verification systems which verify that safety sounds have been played in amongst other audio content in vehicles.

### SUMMARY

An enhanced digital audio safety verification system in a vehicle is provided herein. The enhanced digital audio safety verification system includes a memory, a processor and an amplifier. The memory is operational to store: a plurality of safety messages within a human-perceptible audio frequency band; and a plurality of safety codes that correspond to the plurality of safety messages and are within an ultrasonic frequency band. The processor is operational to: receive a safety context of a vehicle; select a corresponding one of the plurality of safety messages and a corresponding one of the plurality of safety codes from the memory based on the safety context; and add the corresponding safety message to the corresponding safety code to generate a coded message. The amplifier is operational to: drive a load with a current based on the coded message; and present to the processor a current feedback signal representative of the current driven to the load while playing the coded message. The processor is further operational to: decode the current feedback signal; and generate a report signal that identifies which of the plurality of safety messages was presented to the load based on the decode of the current feedback signal.

In one or more embodiments, the system includes a source of a content operational to present the content to the processor.

In one or more embodiments of the system, the processor is further operational to transfer the content to the amplifier; and the amplifier is operational to drive the load further based on the content.

In one or more embodiments, the system includes a plurality of sensors coupled to the processor and operational to sense a plurality of conditions related to the safety context of the vehicle.

In one or more embodiments of the system, the processor includes: an audio digital signal processor operational to receive the safety context of the vehicle; and a vehicle interface processor operational to determine if a presented safety message was actually presented to the load.

In one or more embodiments of the system, the vehicle interface processor is further operational to: generate the report signal; and present the report signal to a user of the vehicle.

In one or more embodiments of the system, the audio digital signal processor is further operational to decode a presented safety code from the current feedback signal.

In one or more embodiments of the system, the audio digital signal processor is further operational to isolate the presented safety code; and transfer the presented safety code to the vehicle interface processor.

In one or more embodiments of the system, the vehicle interface processor is further operational to: compare the corresponding safety code as selected from the memory with the presented safety code as decoded by the audio digital signal processor; and generate the report signal in response to the comparison indicating a match.

A method of enhanced digital audio safety verification is provided. The method includes storing in a memory: a plurality of safety messages within a human-perceptible audio frequency band; and a plurality of safety codes that correspond to the plurality of safety messages and are within an ultrasonic frequency band; receiving a safety context of a vehicle at a processor; selecting a corresponding one of the plurality of safety messages and a corresponding one of the plurality of safety codes from the memory based on the safety context in the processor; adding the corresponding safety message to the corresponding safety code to generate a coded message in the processor; driving with an amplifier a load with a current based on the coded message; presenting from the amplifier to the processor a current feedback signal representative of the current driven to the load while playing the coded message; decoding the current feedback signal in the processor; and generating a report signal with the processor that identifies which of the plurality of safety messages was presented to the load based on the decode of the current feedback signal.

In one or more embodiments, the method includes presenting a content from a source to the processor.

In one or more embodiments, the method includes transferring the content from the processor to the amplifier, where driving the load is further based on the content.

In one or more embodiments, the method includes sensing a plurality of conditions related to the safety context of the vehicle with a plurality of sensors.

In one or more embodiments of the method, the processor includes: an audio digital signal processor operational to receive the safety context of the vehicle; and a vehicle interface processor operational to determine if a presented safety message was actually presented to the load.

In one or more embodiments, the method includes generating the report signal with the vehicle interface processor; and presenting the report signal to a user of the vehicle.

In one or more embodiments, the method includes decoding a presented safety code from the current feedback signal with the audio digital signal processor.

In one or more embodiments, the method includes isolating the presented safety code with the audio digital signal processor; and transferring the presented safety code to the vehicle interface processor.

In one or more embodiments, the method includes comparing with the vehicle interface processor the corresponding safety code as selected from the memory with the presented safety code as decoded by the audio digital signal processor, where the generating of the report signal in response to the comparing indicating a match.

A vehicle is provided herein. The vehicle includes a memory, a processor, a speaker and an amplifier. The memory is operational to store: a plurality of safety messages within a human-perceptible audio frequency band; and a plurality of safety codes that correspond to the plurality of safety messages and are within an ultrasonic frequency band. The processor is operational to: receive a safety context of a vehicle; select a corresponding one of the plurality of safety messages and a corresponding one of the plurality of safety codes from the memory based on the safety context; and add the corresponding safety message to the corresponding safety code to generate a coded message. The amplifier is operational to: drive the speaker with a current based on the coded message; and present to the processor a current feedback signal representative of the current driven to the speaker while playing the coded message. The processor is further operational to: decode the current feedback signal; and generate a report signal that identifies which of the plurality of safety messages was presented to the speaker based on the decode of the current feedback signal.

In one or more embodiments, the vehicle includes a source of a content operational to present the content to the processor, where: the processor is further operational to transfer the content to the amplifier; and the amplifier is operational to drive the speaker further based on the content.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a vehicle with an enhanced digital audio safety system.

FIG. 2 illustrates a schematic diagram of an electronics circuit and preprocessing operations.

FIG. 3 illustrates a flow diagram of an operation of the system.

FIG. 4 illustrates a graph of a pattern injection of a safety code into a safety message.

FIG. 5 illustrates a graph of a safety code structure.

FIG. 6 illustrates a graph of a coded message structure plus a requested content song.

FIG. 7 illustrates a graph of a coded message structure plus filtered noise.

FIG. 8 illustrates a graph of a coded message structure plus white noise.

FIG. 9 illustrates a graph of a non-zero discrete Fourier transfer coefficients on a Hann window.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a system and/or method for a digital audio verification system that confirms a playback of safety audio files through a loudspeaker by an audio amplifier, without including external measurement or listening devices. The system ensures seamless operation alongside user-requested audio material and eliminates dedicated reproduction channels for the safety audio files. The system/method embeds non-audible patterns into safety audio files during a system design phase. Each pattern contains a unique identifier (ID) (e.g., a safety code) and a progress counter that ensures correct sequence playback. When a safety processor triggers a playback of a safety audio file, the digital audio source stimulates an audio amplifier with material containing the non-audible safety pattern. An amplifier generates a voltage waveform with matching frequencies, causing a consumption of current with a frequency content that matches the non-audible safety pattern, a corresponding safety message, and audible user-requested material. The amplifier reports the resulting current data to an audio processing device, which extracts the tag (ID and counter) from the current data. The safety processor verifies the ID and counter to confirm an identity of the material being played.

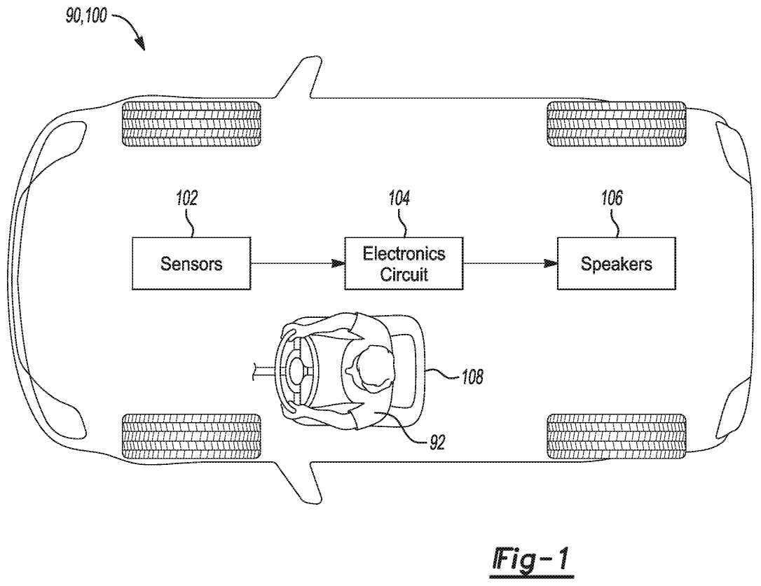

FIG. 1 illustrates an example implementation of a vehicle 90 with an enhanced digital audio safety system 100. The vehicle 90 includes one or more sensors 102, an electronics circuit 104, one or more loudspeakers 106 (or “speakers” for short) and a driver seat 108. A user 92 may occupy the driver seat 108 while the vehicle 90 is being operated.

The vehicle 90 may include mobile vehicles such as automobiles, trucks, motorcycles, boats, trains and/or aircraft. Other types of vehicles may be implemented to meet the design criteria of a particular application.

The user 92 may be a driver or other occupant of the vehicle 90. The user 92 may hear audio signals generated by the speakers 106 within a human-perceptible audio frequency band. Sounds in an ultrasonic frequency band may be imperceptible to the user 92.

The sensors 102 are operational to sense one or more conditions of the vehicle 90 that the user 92 may benefit from being notified about. The conditions are generally classified by an Automotive Safety Integrity Level (ASIL) risk classification scheme defined by the International Organization for Standardization (ISO) 26262-Functional Safety for Road Vehicles standard. The ASIL classifications range from ASIL D, a highest degree of automotive hazard and highest degree of rigor applied in the assurance the resultant safety criteria, to ASIL A, a lowest rating of functional safety. Examples include, but are not limited to, loss of braking on the wheels, loss of cruise control, loss of headlights, and loss of taillights.

The speakers 106 are one or more audio speakers that may be audible to the user 92. The speakers 106 generally reproduce sounds in a human-audible range of 20 hertz to 20,000 hertz. Other ranges may be implemented to meet the criteria of a particular application.

The electronics circuit 104 implement multiple processors, memory, and an audio amplifier. The electronics circuit 104 is operational to receive electrical signals from the sensors 102 and determine if and when a condition rises to an ASIL A to ASIL D level. In response to detecting such conditions, the electronics circuit 104 is further operational to generate a coded message by summing an audible corresponding safety message, an inaudible corresponding safety code and, if playing when the condition occurs, a requested non-safety audible content. The coded message is used to drive the speakers 106 to play the audible corresponding safety message (and potentially the inaudible safety code) at a predetermined volume. In various embodiments, a volume of the requested non-safety audible content may be lowered while the presented safety message is being played for ease of understanding by the user 92.

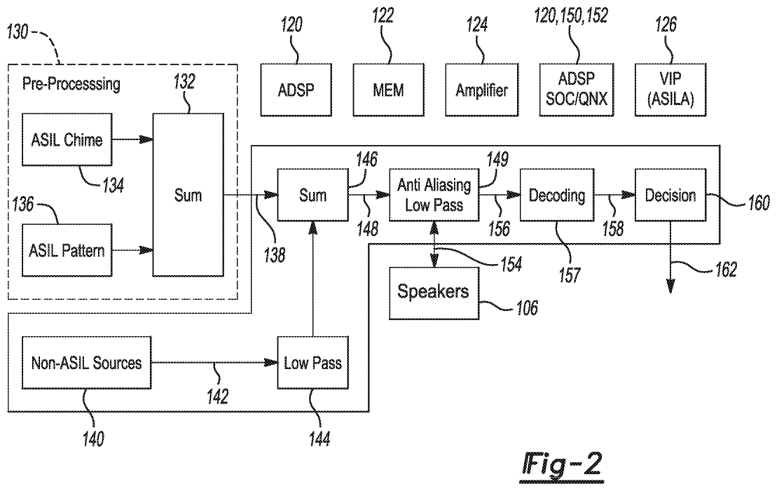

FIG. 2 illustrates a schematic diagram of an example implementation of the electronics circuit 104 and preprocessing is shown in accordance with one or more exemplary embodiments. The electronics circuit 104 includes an audio digital signal processor 120, a nonvolatile memory 122, an audio amplifier 124, and a vehicle interface processor (VIP) 126 playing the role of a safety processor.

A preprocessing 130 is operational to combine 132 safety chimes 134 (e.g., ASIL chimes or safety messages) and safety codes 136 (e.g., ASIL patterns) to create combined safety messages 138. The combined safety messages 138 are stored in the nonvolatile (persistent) memory 122 (e.g., flash memory) within the electronics circuit 104. The safety chimes 134 are messages and/or tones within an audible hearing range of the user 92, and are not normalized. The safety codes 136 are ultrasonic (inaudible) and may be implemented as multiple (e.g., 4096) samples per window with multi-bit (e.g., 32 bits) payloads. The safety codes 136 may have a zero decibel (0 dB) reference amplitude relative to a 0 dB pink noise at the pattern frequency. The resulting safety messages may be attenuated per the ASIL specification.

Prerecorded non-ASIL sources 140 of content 142 are also digitized and stored in the nonvolatile memory 122 within the electronics. Live non-ASIL content (e.g., radio music) may be received by the electronics circuit 104.

The audio digital signal processor (ADSP) 120 is operational to perform a low-pass filtering 144 and non-ASIL attenuation of the prerecorded content and live content. 142 An upper cutoff frequency (Fc) of the content 142 may be approximately 20,000 hertz. In various embodiments, the low pass filter may be 3 biquad filters that provide −80 dB attenuation at 22,000 hertz. Other types of low-pass filters may be implemented to meet the design criteria of a particular application. The ADSP 120 is further operational to sum 146 an active combined safety message 138 with the currently playing requested content 142 to generate a coded message 148. The coded message 148 is presented to an antialiasing low pass filter 149 and the audio amplifier 124. The ADSP 120 may be a system on a chip 150 (SOC) running a QNX operating system 152.

The audio amplifier 124 implements a single-channel or multi-channel amplifier. The audio amplifier 124 is operational to convert the coded message 148 from a digital domain into an analog domain, amplify the resulting analog signal(s) and driving the speakers 106. In various embodiments, the audio amplifier 124 may include an anti-aliasing low pass filtering of the analog signals. An example audio amplifier 124 may be a TAS6584-Q1 amplifier, available from Texas Instruments Incorporated, Dallas, Texas.

During playback, the audio amplifier 124 is further operational to monitor and report an output current 154 used to drive each output channel to the speakers 106. The output current 154 is measured and reported to the ADSP 120 in a current feedback signal 156. The ADSP 120 decodes 157 the corresponding (current) safety code 136 from the current feedback signal 156 and presents a safety code 158 to the VIP 126 for a decision 160.

The VIP 126 implements an ASIL A or ASIL B processor. The VIP 126 is operational to determine if the corresponding safety code 136 was actually played by the enhanced digital audio safety system 100. A result of the determination is presented as a report signal 162 to the user 92 (e.g., the VIP requesting the safety chime), stored in the memory and/or transmitted externally to the vehicle 90.

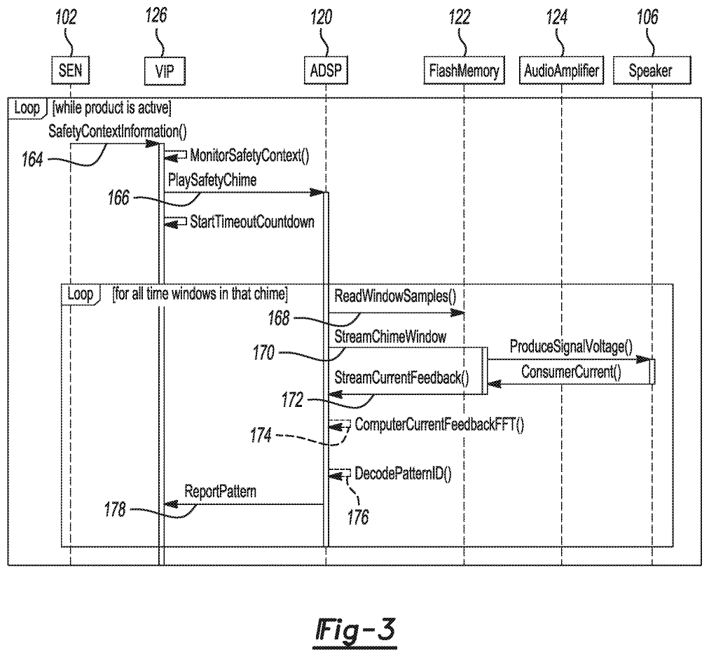

FIG. 3 illustrates a flow diagram of an example operation of the system is shown in accordance with one or more exemplary embodiments. The flow diagram is implemented by the VIP 126 in the electronics circuit 104, the ADSP 120, the nonvolatile memory 122, the audio amplifier 124 and the speakers 106.

The VIP 126 is operational monitor one or more conditions 164 of the vehicle 90 via data from the sensors 102. When an ASIL A or higher condition occurs, the VIP 126 notifies the VIP via a warning signal, The ADSP 120 is instructed by the VIP 126 to read the corresponding coded message (e.g., corresponding safety message and corresponding safety code) from the nonvolatile memory 122. The coded message is subsequently presented to the audio amplifier 124.

The audio amplifier 124 converts the coded message into the analog domain at a predetermined volume. While the coded message is being played 166, 168 and 170, the audio amplifier 124 measures the current 172 used in the playback to generate a current feedback signal in the digital domain. The current feedback signal includes at least the safety message and the safety code. If a requested content is played along with the coded message, the current feedback signal includes the requested content. The current feedback signal is returned to the ADSP 120.

The safety code within the current feedback signal 172 is decoded 174 by the ADSP 120. The ADSP 120 subsequently isolates 176 the decoded safety code and transfers 178 a presented safety code to the VIP 126. The VIP 126 compares the presented (decoded) safety code to the original safety code read from the memory 122 and used with the safety message. If the original safety code and the presented safety code match, the safety message is confirmed to have been played to the user 92 through the speakers 106 and a report is generated stating the successful playing of the safety message. If the original safety code and the presented safety code do not match, an error is reported.

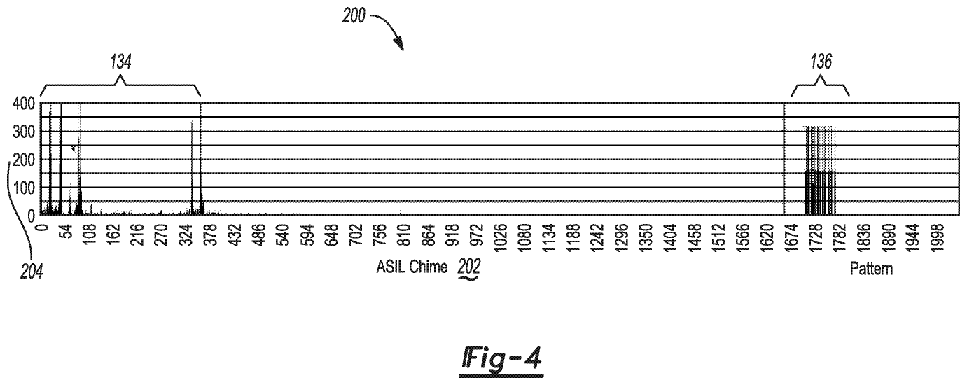

FIG. 4 illustrates a graph 200 of an example pattern injection of a safety code into a safety message is shown in accordance with one or more exemplary embodiments. An X-axis 202 of the graph represents frequency bins. A Y-axis 204 of the graph represents amplitude.

The safety message 134 generally occupies the lower audio frequency range, in the example from a zero-frequency bin to an approximately 837 frequency bin. In the example, a Fast Fourier Transfer (FFT) window size is set to 4096 (e.g., an 85 millisecond window with a 48,000 hertz sampling frequency). A base frequency is set to 22, 000 hertz (after the non-safety cut-off). The safety code 136 is a payload with a 32-bit value (e.g., 0×1234ABCD hexadecimal). A dead band of at least 1 bin is used to avoid frequency leakage. In the example, even frequency carriers are used. In other examples, odd frequency carriers may be used. A level of the safety code 136 is set to match a peak level of the safety message 134.

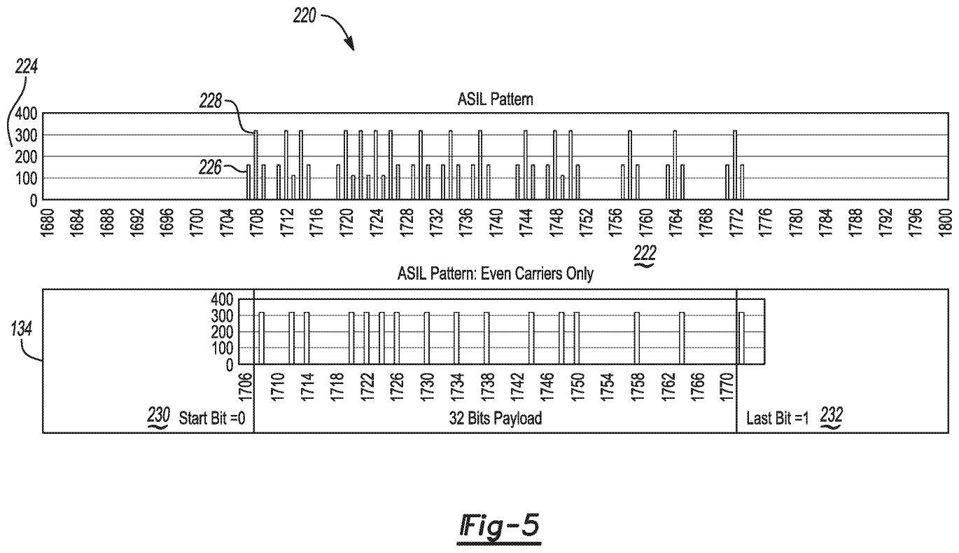

FIG. 5 illustrates a graph 220 of an example safety code structure is shown in accordance with one or more exemplary embodiments. An X-axis 222 of the graph represents frequency bins. A Y-axis 224 of the graph represents amplitude.

Frequency leakage is an artifact of the discrete Fourier transform processing. The frequency leakage is caused by signal truncation at time window boundaries. Therefore, odd harmonics 226 appear in the example due to leakage of the even harmonics 228. The odd harmonics 226 are ignored during the decoding.

The safety code 136 in the example is a multi-bit (e.g., 34-bit) code. A first bit may be a start bit set to a logical zero (a low amplitude). A last bit in the safety code may be an end bit set to a logical one (a high amplitude).

A detection threshold is set as a median amplitude (e.g., minimum amplitude+maximum amplitude)/2). The presence of the start bit 230 and the end bit 232 guarantee the presence of both a logical zero and a logical one in the start code. The 34-bit code is a combination of one start bit, a 32-bit payload value, and one end bit. At two frequencies per bit, 68 frequency bins in total exist for the start code. A bandwidth of the start code is 48 kilohertz×68 frequency bins/4096 FFT window size=800 hertz.

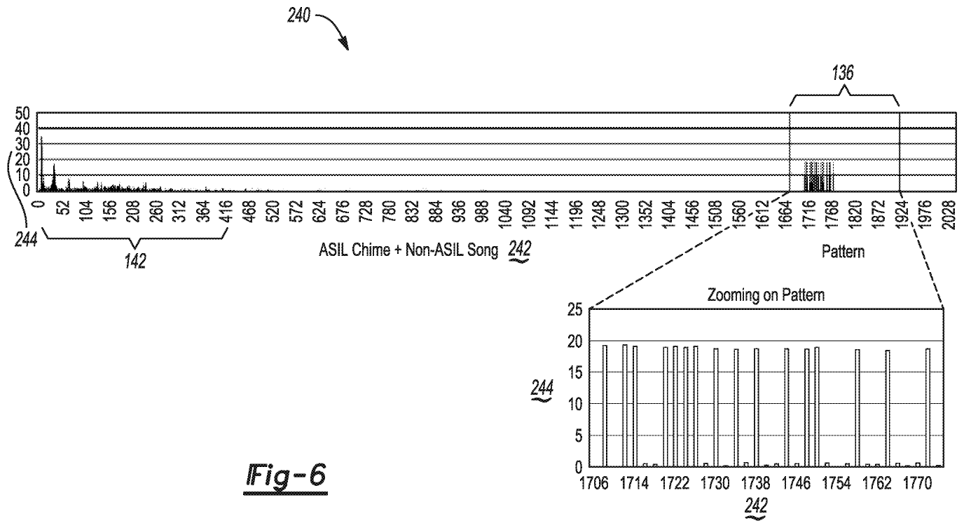

FIG. 6 illustrates a graph 240 of an example coded message structure plus a requested content song 142 is shown in accordance with one or more exemplary embodiments. An X-axis 242 of the graph represents frequency bins. A Y-axis 244 of the graph represents amplitude.

In the example, the noise generated by non-safety sources is attenuated above 22 kilohertz. The 32-bit “fingerprint” of the safety code 136 may be parsed from the current feedback signal due the higher frequency. Small variations in the logical zero amplitudes and the logical one amplitudes may be observed in the safety code pattern. A high detection quality (e.g., >905) may be obtained. The quality is defined as the area between the smallest logical one amplitude and the biggest logical zero amplitude.

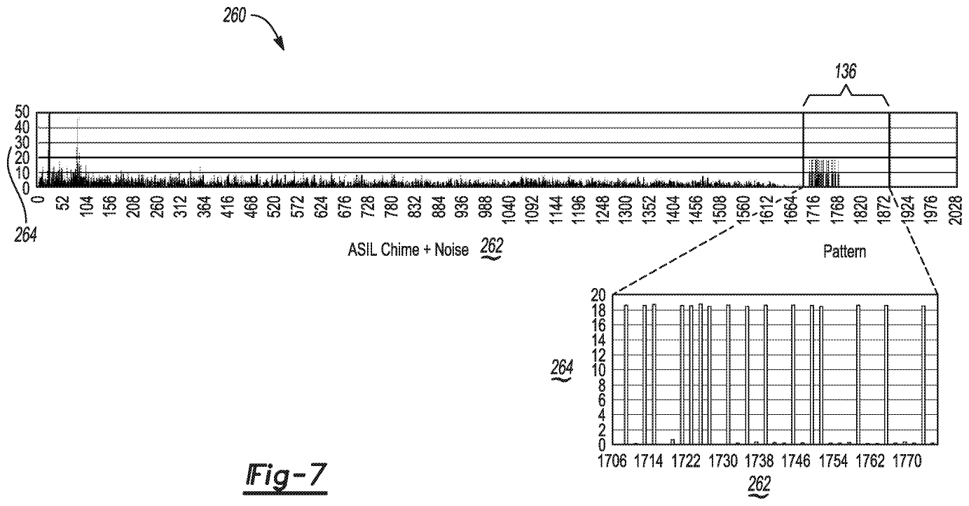

FIG. 7 illustrates a graph 260 of an example coded message structure plus filtered noise is shown in accordance with one or more exemplary embodiments. An X-axis 262 of the graph represents frequency bins. A Y-axis 264 of the graph represents amplitude.

In the example, the 32-bit “fingerprint” of the safety code 136 is correctly decoded. The small variations in the logical zero amplitudes and the logical one amplitudes may be observed in the safety code pattern. The detection quality is greater than 84%.

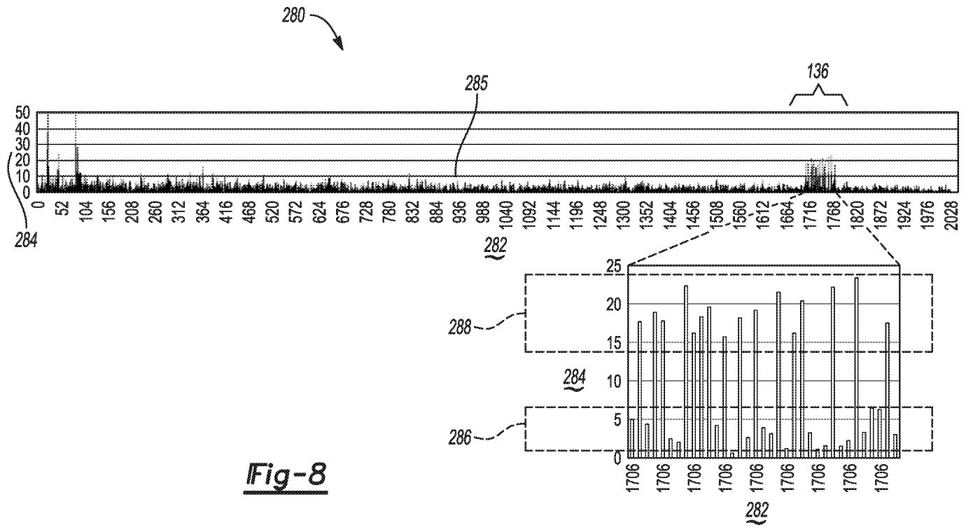

FIG. 8 illustrates a graph 280 of an example coded message structure plus white noise is shown in accordance with one or more exemplary embodiments. An X-axis 282 of the graph represents frequency bins. A Y-axis 284 of the graph represents amplitude. In the example, the white noise 285 extends into the frequency band used by the safety code 136. This example is a stress test of the system and is not expected in real systems.

Significant variations are seen between the logical zero amplitudes 286 and the logical one amplitudes 288. Decoding of the safety code 136 is successful for 41 windows with the quality between 22% and 59%. The decoding failed in the example for 1 window where the quality fell to 13%.

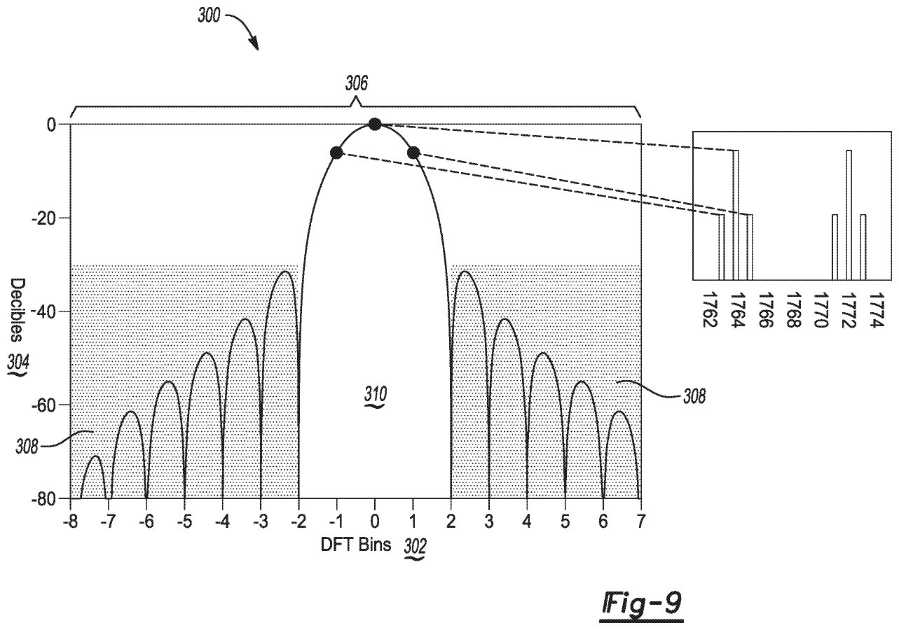

FIG. 9 illustrates a graph 300 of an example non-zero discrete Fourier transfer coefficients on a Hann window is shown in accordance with one or more exemplary embodiments. An X-axis 302 of the graph represents frequency bins. A Y-axis 304 of the graph represents amplitude in decibels.

With a Hann window 306, most of the frequency leakage 308 is contained within intermediately adjacent bins. The energy from the original signal is concentrated in the neighboring frequency slots, reducing the amount of leakage into other slots. As illustrated, from a central slot 310, a −6 dB leakage occurs on adjacent slots (50% amplitude). The leakage may be <30 dB after the second slot on either side of the central slot 310. Other types of window functions may be implemented to meet the design criteria of a particular application. For example, limiting the application to even harmonics means that the Hann windowing and a Hanning windowing are appropriate. Examples of other windows include, but are not limited to Rectangular, Turkey, Backman and Flattop.

System Components of the enhanced digital audio safety verification system include a nonvolatile memory (e.g., persistent storage device), a digital audio source, an audio amplifier, an audio processing device, and a VIP. The nonvolatile memory generally stores preprocessed safety message files, such as alarms and emergency announcements (e.g., a lane departure warning chime). The digital audio source provide by both safety audio and non-safety audio. The audio amplifier is operational to receive digital audio, drive the speakers, and report resultant audio current at the sample rate of the received digital audio. The audio processing device (e.g., the ADSP) is connected to a digital output port of the audio amplifier to receive the per-audio-sample current feedback data. The VIP is operational to monitor the sensor data to trigger a safety playback. The VIP is also operational to monitor an output report of the audio processing device.

In operation, the non-audible safety code is injected into the safety audio files during a system design preprocessing phase. The safety code patterns carry a tag with a unique identification value and a counter value. The VIP triggers a playback of a particular safety audio file through the digital audio source. The digital audio source provides the audio amplifier with material containing the non-audible safety code pattern. The audio amplifier generates voltage waveform with matching frequencies to drive the speakers. The audio amplifier also reports resulting current feedback data to the audio processing device. The audio processing device subsequently extracts the tag (ID and counter) from current feedback data. The VIP extracts the ID of the corresponding safety message and the counter from the tag. The VIP subsequently verifies if the ID match the ID of the expected safety audio file and monitors the progression counter.

Various embodiments of the system use a method of injecting a known pattern into the audio of the safety sound and then, through a process of interrogation and filtering techniques, the current driving the speakers is analyzed and the injected audio pattern energy may be detected and verified using solely a single audio channel. The system generally provides safety audio verification without implementing external sensing devices. Safety-related implementation in the VIP is of low complexity. The system is able to operate seamlessly alongside user-requested audio material. The system eliminates dedicated reproduction channels for the safety audio. The system/method ensures that correct playback of safety alarms occurred in vehicles, industrial plants and/or public transportation systems.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. An enhanced digital audio safety verification system comprising:
a memory operational to store:
a plurality of safety messages within a human-perceptible audio frequency band; and
a plurality of safety codes that correspond to the plurality of safety messages and are within an ultrasonic frequency band;
a processor operational to: receive a safety context of a vehicle;
select a corresponding one of the plurality of safety messages and a corresponding one of the plurality of safety codes from the memory based on the safety context; and
add the corresponding safety message to the corresponding safety code to generate a coded message; and
an amplifier operational to:
drive a load with a current based on the coded message; and
present to the processor a current feedback signal representative of the current driven to the load while playing the coded message;
wherein the processor is further operational to:
decode the current feedback signal; and
generate a report signal that identifies which of the plurality of safety messages was presented to the load based on the decode of the current feedback signal.

2. The enhanced digital audio safety verification system according to claim 1, further comprising:
a source of a content operational to present the content to the processor.

3. The enhanced digital audio safety verification system according to claim 2, wherein:
the processor is further operational to transfer the content to the amplifier; and
the amplifier is operational to drive the load further based on the content.

4. The enhanced digital audio safety verification system according to claim 1, further comprising:
a plurality of sensors coupled to the processor and operational to sense a plurality of conditions related to the safety context of the vehicle.

5. The enhanced digital audio safety verification system according to claim 1, wherein the processor includes:
an audio digital signal processor operational to receive the safety context of the vehicle; and
a vehicle interface processor operational to determine if a presented safety message was actually presented to the load.

6. The enhanced digital audio safety verification system according to claim 5, wherein the vehicle interface processor is further operational to:
generate the report signal; and
present the report signal to a user of the vehicle.

7. The enhanced digital audio safety verification system according to claim 5, wherein:
the audio digital signal processor is further operational to decode a presented safety code from the current feedback signal.

8. The enhanced digital audio safety verification system according to claim 7, wherein:
the audio digital signal processor is further operational to isolate the presented safety code; and
transfer the presented safety code to the vehicle interface processor.

9. The enhanced digital audio safety verification system according to claim 8, wherein the vehicle interface processor is further operational to:
compare the corresponding safety code as selected from the memory with the presented safety code as decoded by the audio digital signal processor; and
generate the report signal in response to the comparison indicating a match.

10. A method of enhanced digital audio safety verification comprising: storing in a memory:
a plurality of safety messages within a human-perceptible audio frequency band; and
a plurality of safety codes that correspond to the plurality of safety messages and are within an ultrasonic frequency band;
receiving a safety context of a vehicle at a processor;
selecting a corresponding one of the plurality of safety messages and a corresponding one of the plurality of safety codes from the memory based on the safety context in the processor;
adding the corresponding safety message to the corresponding safety code to generate a coded message in the processor;
driving with an amplifier a load with a current based on the coded message;
presenting from the amplifier to the processor a current feedback signal representative of the current driven to the load while playing the coded message;
decoding the current feedback signal in the processor; and
generating a report signal with the processor that identifies which of the plurality of safety messages was presented to the load based on the decode of the current feedback signal.

11. The method according to claim 10, further comprising:
presenting a content from a source to the processor.

12. The method according to claim 11, further comprising:
transferring the content from the processor to the amplifier, wherein:
driving the load is further based on the content.

13. The method according to claim 10, further comprising:
sensing a plurality of conditions related to the safety context of the vehicle with a plurality of sensors.

14. The method according to claim 10, wherein the processor includes:
an audio digital signal processor operational to receive the safety context of the vehicle; and
a vehicle interface processor operational to determine if a presented safety message was actually presented to the load.

15. The method according to claim 14, further comprising:
generating the report signal with the vehicle interface processor; and
presenting the report signal to a user of the vehicle.

16. The method according to claim 14, further comprising:
decoding a presented safety code from the current feedback signal with the audio digital signal processor.

17. The method according to claim 16, further comprising:
isolating the presented safety code with the audio digital signal processor; and
transferring the presented safety code to the vehicle interface processor.

18. The method according to claim 17, further comprising:
comparing with the vehicle interface processor the corresponding safety code as selected from the memory with the presented safety code as decoded by the audio digital signal processor, wherein:
the generating of the report signal in response to the comparing indicating a match.

19. A vehicle comprising:
a memory operational to store:
a plurality of safety messages within a human-perceptible audio frequency band; and
a plurality of safety codes that correspond to the plurality of safety messages and are within an ultrasonic frequency band;
a processor operational to:
receive a safety context of a vehicle;
select a corresponding one of the plurality of safety messages and a corresponding one of the plurality of safety codes from the memory based on the safety context; and
add the corresponding safety message to the corresponding safety code to generate a coded message;
a speaker; and
an amplifier operational to:
drive the speaker with a current based on the coded message; and
present to the processor a current feedback signal representative of the current driven to the speaker while playing the coded message;
wherein the processor is further operational to:
decode the current feedback signal; and
generate a report signal that identifies which of the plurality of safety messages was presented to the speaker based on the decode of the current feedback signal.

20. The vehicle according to claim 19, further comprising:
a source of a content operational to present the content to the processor, wherein:
the processor is further operational to transfer the content to the amplifier; and
the amplifier is operational to drive the speaker further based on the content.
